(19) United States
(12) Patent Application Publication
(10) Pub. No.: US 2008/0142132 A1
(43) Pub. Date: Jun. 19, 2008

(54) Pneumatic vehicle tire with cap/base tread

(75) Inventors: Jens Kleffmann, Hannover (DE); Matthias Haufe, Neustadt (DE); Christian Weber, Garbsen (DE)

Correspondence Address: COLLARD & ROE, P.C., 1077 NORTHERN BOULEVARD, ROSLYN, NY, 11576, US

(73) Assignee: CONTINENTAL AKTIENGESELLSCHAFT

(21) Appl. No.: 12/072,215

(22) Filed: Feb. 25, 2008

Related U.S. Application Data
(63) Continuation of application No. PCT/EP2006/008997, filed on Sep. 15, 2006.

(30) Foreign Application Priority Data
Oct. 14, 2005 (DE) 102005049183.9

(51) Int. Cl. B60C 11/00

(52) U.S. Cl. 152/209.5; 152/532

(57) ABSTRACT

The invention relates to a vehicle tire, especially utility vehicle tire, comprising a tread which has a tread cap (9) and a tread base (8), both produced from a rubber mixture, and a multilayer ply structure (3, 4, 5, 6) with at least one undertread strip (7, 7′) covering the ply edges and separating the same from the tread base, said undertread strip being likewise produced from a rubber mixture. The aim of the invention is to reduce temperature and heat build-up in the area of the ply edges. For this purpose, the tread base (8) has a heat conductivity that is by at least 20% higher than that of the tread cap (9) and a heat conductivity that is by at least 10% higher than that of the one or more undertread strips (7, 7′), and the tread base (8) contains at least 25 phr of acetylene black.

The invention relates to a pneumatic vehicle tire, in particular a tire for a commercial vehicle, with a tread rubber, which has a tread rubber cap and a tread rubber base that are in each case produced from a rubber mixture, and with at least one multiply breaker belt assembly with at least one undertread rubber that is produced from a rubber mixture, covering the breaker edges and separating them from the tread rubber base.

During the use or operation of a tire, the flexing forces and centrifugal forces that occur and the associated dynamic deformations caused by the loss of hysteresis of the vulcanized rubber mixtures in the tire cause the development of thermal energy, which can only be dissipated poorly. A distinct development of heat, accompanied by increased temperature, occurs in particular in the vicinity of the breaker edges. This leads to an impairment in the durability of the tire and in the feasibility of retreading the tire. As a result of the increase in modulus at the ends of the reinforcing elements (breaker edges), the high deformations occurring and the accompanying mechanical loads, the breaker edges are also exposed to high structural loads. The stresses and loads may result in instances of breaker edge loosening and detachment that not only impair the feasibility of retreading but may also lead to a breaker belt coming away completely or even the tire being destroyed.

In the case of tires that are exposed to particular thermal loads, it is state of the art to divide the tread rubber into a cap and a base. The rubber mixture for the tread rubber base has in this case the task of reducing the buildup of heat. Therefore, carbon blacks that have a lower activity (a lower BET surface area and a lower CTAB surface area) than those carbon blacks that are used in the mixture for the tread rubber cap are used in the rubber mixture for the tread rubber base. Furthermore, the entire filler content in the base mixture is usually lower than that in the cap mixture. The hardness of the tread rubber base is therefore often less than the hardness of the tread rubber cap.

It is known from DE-A-1755301 to reduce the development of temperature in the pneumatic vehicle tire, and in particular in the tread, by the tire—and in particular the tire tread—containing graphite that is homogeneously incorporated in the rubber. Therefore, in the case of conventional crossply tires, a tread rubber that is produced in its entirety from a rubber mixture containing graphite consequently makes it possible by its improved thermal conductivity to reduce the temperature in the shoulders of the tread rubber. The adding of graphite to rubber mixtures specifically for tread rubbers has the consequence, however, that the properties of the vulcanized mixtures change. The inclusion of graphite in rubber mixtures for tread rubbers has the effect, for example, of adversely influencing the wet grip, dry grip and, in particular, abrasion. One of the reasons to which this is attributable is the sliding properties of the graphite particles.

To lower the temperature of rubber mixtures effectively in the region near the breaker belt of pneumatic vehicle tires, in EP-A-1 031 441 it is proposed to arrange at the base of the tread grooves and in the region of the tire shoulders a rubber mixture with a thermal conductivity that is at least 5% higher than the thermal conductivity of the rubber mixtures surrounding it. To increase the thermal conductivity of the mixtures, fillers such as aluminum, magnesium, copper, tin, nickel or metal-containing substances such as, for example, zinc oxide, aluminum hydroxide and the like are proposed as additives in addition to carbon black.

The invention is based on the object of finding a particularly effective measure for reducing the development of temperature and heat in the region of the breaker edges, without reducing the mechanical properties in these regions, in particular the tearing properties, and without worsening the abrasion of the tread rubber.

The set object is achieved according to the invention by the tread rubber base having a thermal conductivity that is at least 20% higher than the tread rubber cap and a thermal conductivity that is at least 10% higher than the undertread rubber or rubbers.

In the case of the invention, it is therefore completely surprising that the thermal energy generated at the breaker edges does not have to be dissipated by a thermally conductive component being made to extend continuously to the outside. The development of heat in the region of the breaker edges, and consequently the occurrence of very high temperatures, take place only in relatively small, local regions. The previous conception was that this heat must be dissipated to the outside to allow the tire to be cooled effectively. It has surprisingly been found that an internal distribution of the heat occurring among components that are subjected to less mechanical stress is entirely adequate to improve the durability of the breaker edges significantly. It is also surprising that it is not essential for every component of the tire that is directly adjacent to the breaker edges to have an increased thermal conductivity. To achieve a significant improvement in the durability of the tire, it is sufficient if the tread rubber base has the increased thermal conductivity mentioned with respect to the tread rubber cap and the undertread rubber. Consequently, good tear resistance at the breaker edges is ensured at the same time.

The higher thermal conductivity of the tread rubber base can be achieved in a particularly easy and effective way by the use of acetylene black in the initial mixture. In this case, the tread rubber base contains at least 25 parts by weight, in particular between 42 and 60 parts by weight, of acetylene black, referred to 100 parts by weight of rubber in the initial mixture.

It is favorable for the tear resistance of the tread rubber base if its Shore A hardness is at most two points lower than that of the tread rubber cap. This measure prevents undesired concentrations of stress and, in particular, avoids the formation of fatigue cracks in the tread rubber base.

The tear resistance of the tread rubber base can also be favorably influenced by the use of certain types of rubber. It is of advantage in this respect if the tread rubber base is produced from a rubber mixture that contains 55 to 100 parts by weight of natural rubber, up to 35 parts by weight of butadiene rubber and up to 10 parts by weight of at least one further rubber, in each case based on 100 parts by weight of rubber in the mixture.

A further measure that is advantageous in this connection is that the tread rubber base is produced from a rubber mixture that contains sulfur in a proportion that is between 0.5 and 2.5 times the proportion of accelerator.

The undertread rubber or rubbers is or are produced with preference from a rubber mixture that contains a steel cord bonding system. This measure is conducive to good bonding of the undertread rubber or rubbers to the cut edges of the steel cords of the breaker plies.

As a result of its somewhat poorer abrasion properties, the tread rubber base should be arranged in the tire in such a way that it lies completely inside the tire and does not reach into the lateral outer regions of the tire.

The abrasion resistance of the tread rubber base can be increased by using between 5 and 20 parts by weight of a carbon black of the type N 326 and/or a carbon black of the type N 339 in addition to acetylene black.

Further features, advantages and details of the invention are described in more detail on the basis of the drawing, which presents exemplary embodiments and in which:

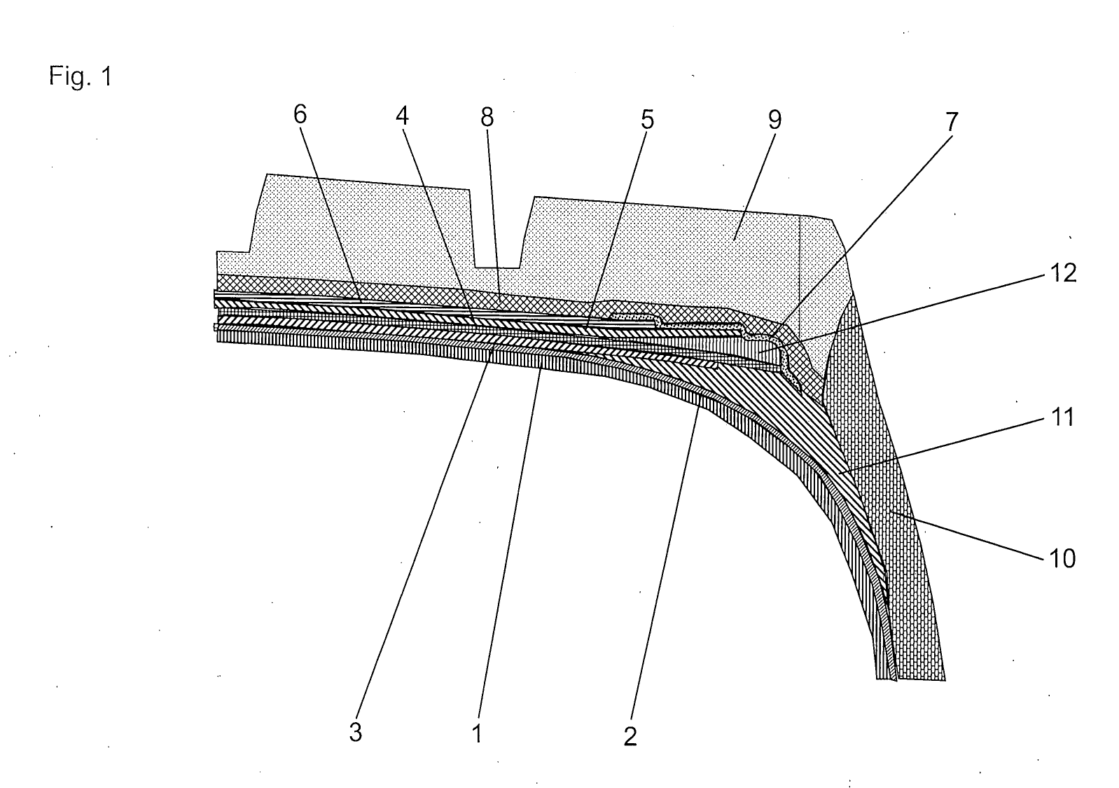

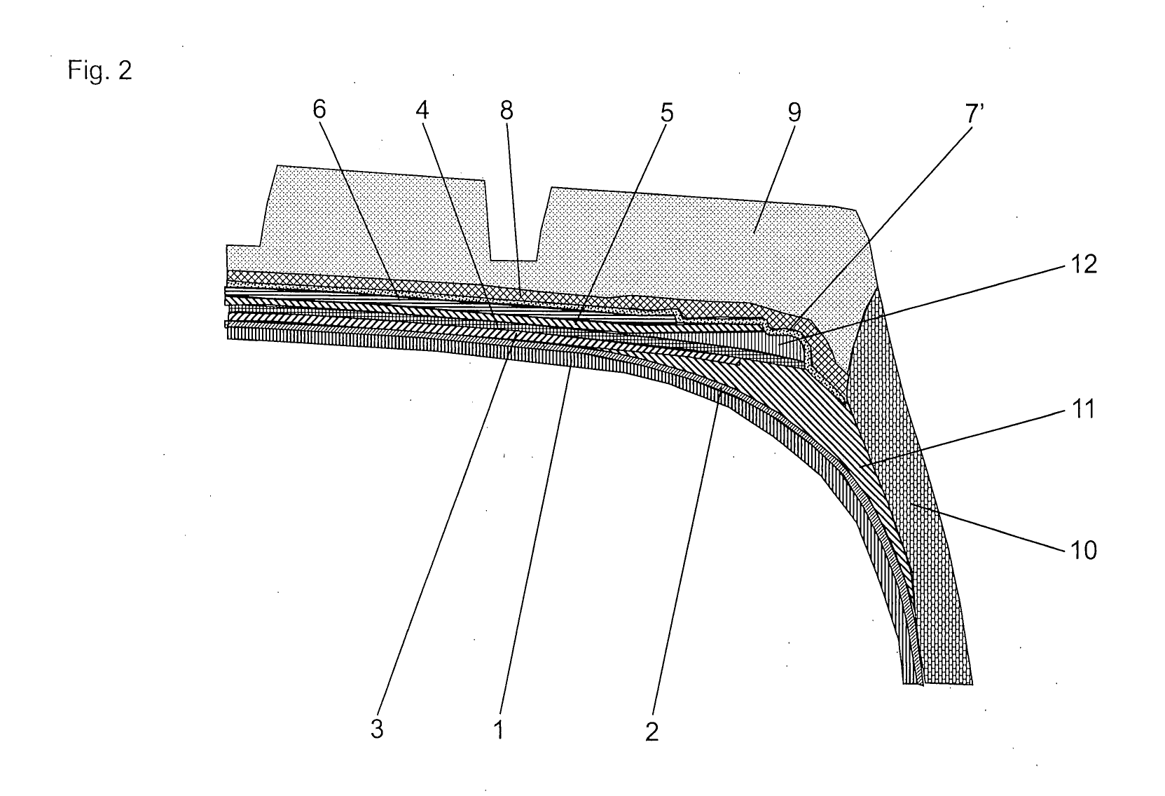

FIG. 1 and FIG. 2 show partial cross sections through a tire in the region of the tread rubber and the breaker belt with two different configurational variants of the invention.

The figures of the drawing show cross sections through one of the upper sidewall regions and the tread rubber region adjoining the latter of a tire for a commercial vehicle. The conventional components of the tire that are represented are standard constructions, for example the carcass insert 2, which is provided in particular with steel cords as reinforcing elements, the airtight inner layer 1, the breaker belt assembly comprising four plies 3, 4, 5 and 6, and the sidewall 10. A shoulder cushion 11 is fitted between the breaker belt assembly, the carcass insert 2 and the side wall 10. The tread rubber comprises a tread rubber cap 9 and a tread rubber base 8; the edges of the breaker plies 4, 5 and 6 are covered by an undertread rubber 7 (FIG. 1) or 7′ (FIG. 2). Tire components that are not represented, for example the bead regions, can be configured in a known way.

In the case of the embodiment represented, the fourth, radially outermost breaker ply 6 has the smallest width of all the plies and is the so-called protective ply, which already ends comparatively far away from the shoulder regions of the tire. The first breaker ply 3 is the so-called barrier ply, the second breaker ply 4 and the third breaker ply 5 are the so-called working plies. All the breaker plies 3, 4, 5 and 6 comprise reinforcing elements, in particular of steel cord, embedded in a rubber mixture, the breaker rubber compound. Steel cords run parallel to one another in each of the plies 3, 4, 5 and 6, but form an angle with the circumferential direction of the tire. For the steel cords of the fourth breaker ply 6, this angle is generally 5° to 25°, for the steel cords of the second and third breaker plies 4, 5 it is between 15° and 25°, with steel cords of the breaker plies 4, 5 crossing one another, and for the steel cords of the first breaker ply 3 it is between 45° and 70°. A breaker cushion 12 of a rubber mixture is introduced between the lateral edge portions of the second and third breaker plies 4, 5. The upper end of the side wall 10 laterally overlaps the tread rubber cap 9. The covering rubber 7, 7′, which covers the edge portions of the breaker plies 5, 6, the breaker cushion 12 and the edge of the breaker ply 4 and is conventionally referred to as the undertread, consists of a rubber mixture and prevents direct contact of the breaker edges of the breaker plies 4, 5 and 6 with the tread rubber base 8. Further constructional variants of the breaker belt with three to five breaker plies or 4- or 5-ply variants with breaker ply angles exclusively between 5° and 25° are possible for use. Breaker belt variants in which one or two plies have an angle of 0° to 5° can also be used.

The tread rubber base 8 extends radially within the cap 9 laterally as far as the sidewalls 10 and has a substantially constant thickness, which is at least 1 mm, at most up to 8 mm. The tread rubber base 8 is produced from a particularly thermally conductive rubber mixture; its thermal conductivity is at least 20% higher than the thermal conductivity of the tread rubber cap 9. In comparison with the rubber mixture that is used for the undertread rubber 7, 7′, the tread rubber base 8 has a thermal conductivity that is at least 10% higher.

The thermal conductivity of the tread rubber base 8 is achieved by the use of acetylene black as a filler. The proportion of acetylene black in the mixture for the base 8 is at least 25 parts by weight, referred to 100 parts by weight of rubber in the mixture.

In this case, at least one further type of carbon black can be used in addition to acetylene black. The overall proportion of carbon black should be at least 40 parts by weight, referred to 100 parts by weight of rubber in the mixture. To achieve the maximum thermal conductivity of the tread rubber base 8, acetylene rubber may be used exclusively. The optimum proportion of acetylene black in the mixture is between 42 and 60 parts by weight.

Acetylene black is produced by thermal decomposition of acetylene and is distinguished by an above-average proportion of graphite-like structures and a very low content of oxygen-containing groups. Acetylene blacks generally have a DBP number (dibutyl phthalate number) according to ASTM-D 2414 of between 150 and 260 cm³/100 g and an iodine absorption number according to ASTM-D 1510 greater than 85 g/kg. The particle diameters of the primary particles lie between 30 and 45 nm.

The further carbon blacks that are possibly added to the tread rubber base mixture are preferably abrasion-resistance carbon blacks, the proportion of which is 5 to 20 parts by weight. Highly abrasion-resistant carbon blacks are furnace blacks, which are distinguished by a high structure with a low particle size. These carbon blacks have an iodine absorption number of 75 to 105 g/kg and a DBP number of 60 to 160 cm³/100 g. Carbon blacks of the type N 326 or the type N 339 come into consideration in particular.

Since acetylene black reduces the tearing of the tread rubber base 8, the Shore A hardness of the tread rubber base 8 should be at most 2 points lower than that of the tread rubber cap 9. This measure prevents undesired concentrations of stress in the tread rubber base 8 during the operation of the tire and avoids the formation of fatigue cracks in the tread rubber base 8. The hardness of the tread rubber base 8 should be between Shore A 55 and Shore A 70.

The lower tear resistance of the tread rubber base 8 can also be compensated to some extent by the use of natural rubber. In addition to natural rubber, butadiene rubber may be used as a second rubber component in the mixture for the tread rubber base 8, since this type of rubber has outstanding tear resistance and tear propagation resistance with low stretching amplitudes. The proportion of butadiene rubber should in this case not exceed 35 parts by weight. In addition to natural rubber and butadiene rubber, other types of rubber can in principle be added, preferably in small amounts, for example styrene-butadiene copolymer (SBR, E-SBR, S-SBR), synthetic polyisopropene (IR) and polybutadiene (BR), where the overall proportion of other types of rubber should not exceed 10 parts by weight.

In the rubber mixture for the tread rubber base 8, a sulfur accelerator system, in which the proportion of sulfur is 0.5 to 2.5 times as high as the proportion of accelerator, is used as the vulcanization system. Thiuram derivatives and morpholine derivatives may in this case be used for example as sulfur donors. As a result of the low tear resistance of the tread rubber base 8, direct contact of the tread rubber base 8 with the cut edges of the cords in the breaker plies 3 to 6 should be avoided. The undertread rubber 7, 7′ prevents direct contact and is produced with preference from a rubber mixture that ensures high tear resistance. The rubber mixture for the undertread rubber 7, 7′ should either not contain any acetylene black or only a small proportion of acetylene black of at most 15 parts by weight. The undertread rubber 7, 7′ has a substantially constant thickness of 0.1 to 3 mm. In this case, as shown in FIG. 1, it may be provided that in each case a rubber 7 substantially covers only the edge regions of the breaker plies 4, 5 and 6, but it may be provided that the rubber 7′ runs over the entire width of the breaker belt or tread rubber, as is shown in FIG. 2.

Good bonding of the undertread rubbers 7, 7′ to the cut edges of the steel cords in the breaker plies 4, 5 and 6 is ensured by the use of a steel cord bonding system in the rubber mixture for the undertread rubbers 7, 7′. The desired steel cord bonding may in this case be achieved by a high proportion of sulfur, by the addition of cobalt salts in combination with resin systems (for example resorcinol, hexamethylene tetramine, hexamethoxymelamine), by a proportion of silica, and by the use of adhesion-promoting substances, such as colophonium or Koresin. The greater buildup of heat in the mixture of the rubber 7, 7′ as a result of the steel cord bonding system is in any event more than compensated by the high thermal conductivity of the tread rubber base 8.

As a result of the low tear resistance and the somewhat poorer abrasion properties of the tread rubber base eight, it does not extend into the lateral outer regions of the tire, as is shown in FIG. 1 and FIG. 2.

Table 1 contains an example of a mixture (M1) for a typical tread rubber cap mixture and two examples of mixtures (M2 and M3) constructed of a tread rubber base mixture made up according to the invention. The specified amounts are parts by weight (phr), which are referred to 100 parts by weight of rubber in the mixture. Test pieces were produced from the mixtures by vulcanisation at 160° C. With these test pieces, some of the material properties typical of the rubber industry are determined, the values of which are contained in Table 2. The following test methods were used on the test pieces:
tensile strength at room temperature according to DIN 53 504
elongation at break at room temperature according to DIN 53 504
static modulus (stress values) under 100%, 200% and 300% elongation at room temperature according to DIN 53 504
Shore A hardness at room temperature and at 70° Celsius according to DIN 53 504
rebound resilience at room temperature and at 70° Celsius according to DIN 53 512
fracture energy density determined in tensile test according to DIN 53 504, the fracture energy density being the work required up until fracture, referred to the volume of the specimen
thermal conductivity with the Kerntherm QTM-D3-PD3 device from Kyoto Electronics according to DIN 52 612 (initial temperature: room temperature)
Graves tear propagation test according to DIN 53 515

TABLE 1

| Constituents | Unit | M1 | M2 | M3 |
|---|---|---|---|---|
| Natural rubber | phr | 100 | 100 | 100 |
| N 121 | phr | 50 | 0 | 0 |
| Acetylene black | phr | 0 | 45 | 53 |
| Antioxidant | phr | 3 | 3 | 3 |
| Anti-ozonant wax | phr | 2.5 | 0 | 0 |
| Tin oxide | phr | 3 | 3 | 3 |
| Stearic acid | phr | 2 | 2 | 2 |
| Accelerator | phr | 1 | 1 | 1 |
| Sulfur | phr | 1.7 | 1.7 | 1.7 |

TABLE 2

| Property | Unit | M1 | M2 | M3 |
|---|---|---|---|---|
| Tensile strength | MPa | 24 | 19.8 | 18.9 |
| Elongation at | % | 530 | 503 | 463 |
| break | | | | |
| Modulus 100% | MPa | 1.9 | 2.33 | 2.7 |
| Modulus 200% | MPa | 5.9 | 0.6 | 7.3 |
| Modulus 300% | MPa | 12.3 | 11.13 | 12.6 |
| Hardness at RT | Shore A | 61.3 | 61.5 | 63.3 |
| Hardness at 70° | Shore A | 56 | 56 | 59.2 |
| Rebound at RT | % | 46.5 | 57.2 | 49.8 |
| Rebound at 70° | % | 55.2 | 65.8 | 57.9 |
| Fracture energy | J/cm³ | 42.2 | 39.5 | 36.4 |
| density | | | | |
| Thermal | W/(m * K) | 0.263 | 0.394 | 0.425 |
| conductivity | | | | |
| Graves | N/mm | 82.5 | 53 | 56 |
| Graves 100° C. | N/mm | 65 | 48.5 | 53.5 |

1: A pneumatic vehicle tire, in particular a tire for a commercial vehicle, with a tread rubber, which has a tread rubber cap (9) and a tread rubber base (8) that are in each case produced from a rubber mixture, and with a multiply breaker belt assembly (3, 4, 5, 6) with at least one undertread rubber (7, 7′) that is likewise produced from a rubber mixture, covering the breaker edges and separating them from the tread rubber base (8), wherein the tread rubber base (8) has a thermal conductivity that is at least 20% higher than the tread rubber cap (9) and a thermal conductivity that is at least 10% higher than the undertread rubber or rubbers (7, 7′).

2: The pneumatic vehicle tire as claimed in claim 1, wherein the tread rubber base (8) contains at least 25 parts by weight of acetylene black, referred to 100 parts by weight of rubber in the initial mixture.

3: The pneumatic vehicle tire as claimed in claim 1, wherein the tread rubber base (8) contains between 42 and 60 parts by weight of acetylene black, referred to 100 parts by weight of rubber in the initial mixture.

4: The pneumatic vehicle tire as claimed in claim 1, wherein the tread rubber base (8) has a Shore A hardness that is at most 2 Shore A points lower than the Shore A hardness of the tread rubber cap (9).

5: The pneumatic vehicle tire as claimed in claim 1, wherein the tread rubber base (8) is produced from a rubber mixture that contains 55 to 100 parts by weight of natural rubber, 0 to 35 parts by weight of butadiene rubber and up to 10 parts by weight of at least one further rubber, in each case based on 100 parts by weight of rubber in the mixture.

6: The pneumatic vehicle tire as claimed in claim 1, wherein the tread rubber base (8) is produced from a rubber mixture that contains sulfur in a proportion that is between 0.5 and 2.5 times the proportion of accelerator.

7: The pneumatic vehicle tire as claimed in claim 1, wherein the undertread rubber (7, 7′) is produced from a rubber mixture that contains a steel cord bonding system.

8: The pneumatic vehicle tire as claimed in claim 1, wherein the tread rubber base (8) lies completely inside the tire.

9: The pneumatic vehicle tire as claimed in claim 1, wherein the tread rubber base (8) is produced from a rubber mixture that contains between 5 and 20 parts by weight of carbon black of the type N 326 and/or of the type N 339 in addition to acetylene black.
